(19) United States
(12) Patent Application Publication
(10) Pub. No.: US 2023/0196022 A1
(43) Pub. Date: Jun. 22, 2023

(54) Techniques For Performing Subject Word Classification Of Document Data

(71) Applicant: TmaxAI Co., Ltd., Gyeonggi-do (KR)

(72) Inventors: Jeonghyun CHOI, Gyeonggi-do (KR); Chunghyeon CHO, Seoul (KR); Sanghak LEE, Gyeonggi-do (KR)

(73) Assignee: TmaxAI Co., Ltd., Gyeonggi-do (KR)

(21) Appl. No.: 17/697,781

(22) Filed: Mar. 17, 2022

(30) Foreign Application Priority Data
Dec. 21, 2021 (KR) 10-2021-0183449

(51) Int. Cl. G06F 40/289; G06F 16/35

(52) U.S. Cl. CPC G06F 40/289; G06F 16/355

(57) ABSTRACT

Disclosed is a method for performing subject word classification of document data, which is performed by a computing device including at least one processor according to some exemplary embodiments of the present disclosure. The method may include: acquiring a plurality of sentence data by using document data; and determining a class of the document data by inputting each of the plurality of sentence data into at least one network model.

### CROSS-REFERENCE TO RELATED APPLICATIONS

This application claims priority to and the benefit of Korean Patent Application No. 10-2021-0183449 filed in the Korean Intellectual Property Office on Dec. 21, 2021, the entire contents of which are incorporated herein by reference.

### TECHNICAL FIELD

The present disclosure relates to a method for performing subject word classification of document data, and particularly, to a method for converting long document data into an embedding vector and classifying a subject word of document data by using the same.

### BACKGROUND ART

In recent years, due to the rapid development and dissemination of smart devices, data of a document which appears on in the Internet web has been increased every day. With the increase in information, a large quantity of documents are increasing on the Internet Web, and as a result, it is difficult for a user to understand the data of the document. Therefore, a study for a technique for classifying the subject of the document is in progress.

In a document embedding technique utilizing a conventional BERT language model, a length of a document which may be embedded is limited to 512 words. Therefore, there is a situation in which a technique for embedding and classifying a long Korean document such as an academic degree thesis is not present.

### SUMMARY OF THE INVENTION

The present disclosure has been made in an effort to provide a method for solving a length limitation problem which occurs in the case of embedding document data.

However, technical objects of the present disclosure are not restricted to the technical object mentioned as above. Other unmentioned technical objects will be apparently appreciated by those skilled in the art by referencing to the following description.

An exemplary embodiment of the present disclosure provides a method for performing subject word classification of document data, which is performed by a computing device including at least one processor according to some exemplary embodiments of the present disclosure. The method may include: acquiring a plurality of sentence data by using document data; and determining a class of the document data by inputting each of the plurality of sentence data into at least one network model.

The acquiring of the plurality of sentence data by using document data may include determining a sentence delimiter in the document data, and acquiring the plurality of sentence data based on the sentence delimiter.

The determining of the sentence delimiter in the document data may include determining the sentence delimiter based on a normal expression equation and a pretrained sentence distinguishing model for a plurality of text data included in the document data.

The pretrained sentence distinguishing model may include an artificial intelligence based model that may receive a sentence included in the document data and output a segment result for the input sentence.

At least one network model may include a first network model determining a plurality of embedding vectors by receiving each of the plurality of sentence data, and a second network model securing embedding for an entire document by receiving an embedding vector for each sentence and determining the class by receiving the plurality of embedding vectors.

The second network model may include an encoder encoding sequences of the plurality of embedding vectors for sentences, and outputting a vector expression for all sentences, i.e., the entire document. In this case, the second network model may include a layer structure including sentence-specific positional information and attention information.

The model focuses on acquiring information on a document from sentences, and provides a method for solution by acquiring embedding of a document from information on sentences.

The class may be related to the subject word of the document data.

The at least one network model may be learned by using a learning data set in which the subject word is labeled to an abstract of each of a plurality of thesis data.

Technical solving means which can be obtained in the present disclosure are not limited to the aforementioned solving means and other unmentioned solving means will be clearly understood by those skilled in the art from the following description.

According to an exemplary embodiment of the present disclosure, provided is a method for solving a length limitation problem which occurs in the case of embedding document data.

Effects which can be obtained in the present disclosure are not limited to the aforementioned effects and other unmentioned effects will be clearly understood by those skilled in the art from the following description.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the detailed matters.

FIG. 1 is a block diagram of a computing device for performing subject word classification of document data according to some exemplary embodiments of the present disclosure.

FIG. 2 is a flowchart for describing an example of a method for performing subject word classification of document data according to some exemplary embodiments of the present disclosure.

FIG. 3 is a flowchart for describing an example of a method for acquiring a plurality of sentence data by using document data according to some exemplary embodiments of the present disclosure.

FIG. 4 is a flowchart for describing an example of a method for performing subject word classification of document data according to some exemplary embodiments of the present disclosure.

FIG. 5 illustrates a simple and general schematic view of an exemplary computing environment in which the exemplary embodiments of the present disclosure may be implemented.

### DETAILED DESCRIPTION

Various exemplary embodiments will now be described with reference to drawings. In the present specification, various descriptions are presented to provide appreciation of the present disclosure. However, it is apparent that the exemplary embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

The term “or” is intended to mean not exclusive “or” but inclusive “or”. That is, when not separately specified or not clear in terms of a context, a sentence “X uses A or B” is intended to mean one of the natural inclusive substitutions. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

It should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

The term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the exemplary embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented exemplary embodiments is provided so that those skilled in the art of the present disclosure use or implement the present disclosure. Various modifications to the exemplary embodiments will be apparent to those skilled in the art. Generic principles defined herein may be applied to other embodiments without departing from the scope of the present disclosure. Therefore, the present disclosure is not limited to the exemplary embodiments presented herein. The present disclosure should be analyzed within the widest range which is coherent with the principles and new features presented herein.

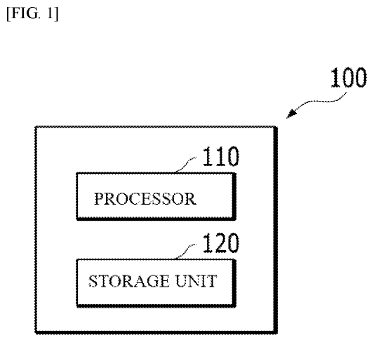

FIG. 1 is a block diagram of a computing device for performing subject word classification of document data according to some exemplary embodiments of the present disclosure.

A configuration of the computing device 100 illustrated in FIG. 1 is only an example shown through simplification. In an exemplary embodiment of the present disclosure, the computing device 100 may include other components for performing a computing environment of the computing device 100 and only some of the disclosed components may constitute the computing device 100.

The computing device 100 may include a predetermined type computer system or computer device such as a microprocessor, a main frame computer, a digital processor, a portable device, or a device controller, for example.

The computing device 100 may include a processor 110 and a storage unit 120. However, components described above are not required in implementing the computing device 100, so the computing device 100 may have components more or less than components listed above.

The processor 110 may be constituted by one or more cores and may include processors for data analysis and deep learning, which include a central processing unit (CPU), a general purpose graphics processing unit (GPGPU), a tensor processing unit (TPU), and the like of the computing device. The processor 110 may read a computer program stored in the memory 130 to perform data processing for machine learning according to some exemplary embodiments of the present disclosure. According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like. At least one of the CPU, GPGPU, and TPU of the processor 110 may process learning of a network function. For example, both the CPU and the GPGPU may process the learning of the network function and data classification using the network function. Further, in an exemplary embodiment of the present disclosure, processors of a plurality of computing devices may be used together to process the learning of the network function and the data classification using the network function. Further, the computer program executed in the computing device according to an exemplary embodiment of the present disclosure may be a CPU, GPGPU, or TPU executable program.

Meanwhile, throughout this specification, a computation model, the neural network, a network function, and the neural network may be used as an interchangeable meaning. That is, in the present disclosure, the computation model, the (artificial) neural network, the network function, and the neural network may be interchangeably used. Hereinafter, the computation model, the neural network, the network function, and the neural network will be integrated into the neural network, and described.

The neural network may be generally constituted by an aggregate of calculation units which are mutually connected to each other, which may be called nodes. The nodes may also be called neurons. The neural network is configured to include one or more nodes. The nodes (alternatively, neurons) constituting the neural networks may be connected to each other by one or more links.

In the neural network, one or more nodes connected through the link may relatively form the relationship between an input node and an output node. Concepts of the input node and the output node are relative and a predetermined node which has the output node relationship with respect to one node may have the input node relationship in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and the weight is variable by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights granted to the respective links in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links which should be passed through for reaching the corresponding node from the initial input node. However, definition of the layer is predetermined for description and the order of the layer in the neural network may be defined by a method different from the aforementioned method. For example, the layers of the nodes may be defined by the distance from a final output node.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean nodes constituting the neural network other than the initial input node and the final output node.

In the neural network according to an exemplary embodiment of the present disclosure, the number of nodes of the input layer may be the same as the number of nodes of the output layer, and the neural network may be a neural network of a type in which the number of nodes decreases and then, increases again from the input layer to the hidden layer. Further, in the neural network according to another exemplary embodiment of the present disclosure, the number of nodes of the input layer may be smaller than the number of nodes of the output layer, and the neural network may be a neural network of a type in which the number of nodes decreases from the input layer to the hidden layer. Further, in the neural network according to yet another exemplary embodiment of the present disclosure, the number of nodes of the input layer may be larger than the number of nodes of the output layer, and the neural network may be a neural network of a type in which the number of nodes increases from the input layer to the hidden layer. The neural network according to still yet another exemplary embodiment of the present disclosure may be a neural network of a type in which the neural networks are combined.

A deep neural network (DNN) may refer to a neural network that includes a plurality of hidden layers in addition to the input and output layers. When the deep neural network (DNN) is used, latent structures of the data may be determined. That is, latent structures of photos, text, video, voice, and music (e.g., what objects are in the photo, what the content and feelings of the text are, what the content and feelings of the voice are) may be determined. The deep neural network may include a convolutional neural network (CNN), a recurrent neural network (RNN), an auto encoder, generative adversarial networks (GAN), a restricted Boltzmann machine (RBM), a deep belief network (DBN), a Q network, a U network, a Siam network, a Generative Adversarial Network (GAN), and the like. The disclosure of the deep neural network described above is just an example and the present disclosure is not limited thereto.

The neural network may be learned in at least one scheme of supervised learning, unsupervised learning, semi supervised learning, or reinforcement learning. The learning of the neural network may be a process of applying knowledge for performing a specific operation to the neural network.

The neural network may be learned in a direction to minimize errors of an output. The learning of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data labeled with a correct answer is used for each learning data (i.e., the labeled learning data) and in the case of the unsupervised learning, the correct answer may not be labeled in each learning data. That is, for example, the learning data in the case of the supervised learning related to the data classification may be data in which category is labeled in each learning data. The labeled learning data is input to the neural network, and the error may be calculated by comparing the output (category) of the neural network with the label of the learning data. As another example, in the case of the unsupervised learning related to the data classification, the learning data as the input is compared with the output of the neural network to calculate the error. The calculated error is back-propagated in a reverse direction (i.e., a direction from the output layer toward the input layer) in the neural network and connection weights of respective nodes of each layer of the neural network may be updated according to the back propagation. A variation amount of the updated connection weight of each node may be determined according to a learning rate. Calculation of the neural network for the input data and the backpropagation of the error may constitute a learning cycle (epoch). A learning rate may be applied differently according to the number of repetition times of the learning cycle of the neural network. For example, in an initial stage of the learning of the neural network, the neural network ensures a certain level of performance quickly by using a high learning rate, thereby increasing efficiency and a low learning rate is used in a latter stage of the learning, thereby increasing accuracy.

In learning of the neural network, the learning data may be generally a subset of actual data (i.e., data to be processed using the learned neural network), and as a result, there may be a learning cycle in which errors for the learning data decrease, but the errors for the actual data increase. Overfitting is a phenomenon in which the errors for the actual data increase due to excessive learning of the learning data. For example, a phenomenon in which the neural network that learns a cat by showing a yellow cat sees a cat other than the yellow cat and does not recognize the corresponding cat as the cat may be a kind of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

According to some exemplary embodiments of the present disclosure, the processor 110 may acquire a plurality of sentence data by using document data. Here, the document data may include thesis document data, patent document data, and journal document data included in a public academic information system. However, the present disclosure is not limited thereto.

The sentence data may include a plurality of texts included in one sentence. However, the present disclosure is not limited thereto.

Meanwhile, the processor 110 may determine a class of the document data by inputting each of the plurality of sentence data into at least one network model. Here, the class of the document data may be data indicating to which subject word the document data is related. However, the present disclosure is not limited thereto.

According to some exemplary embodiments of the present disclosure, the storage unit 120 may store any type of information generated or determined by the processor 110 or any type of information received by the network unit.

The storage unit 120 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the storage unit 120 on the Internet. The description of the storage unit 120 is just an example and the present disclosure is not limited thereto.

According to some exemplary embodiments of the present disclosure, the storage unit 120 may store at least one network model. However, the present disclosure is not limited thereto.

At least one network model may include a first network model determining an embedding vector by receiving the sentence data and a second network model determining the subject word by receiving an embedding model. However, although not limited thereto, the at least one network model may include network models more or less than the network models.

Meanwhile, the second network model may include an encoder that encodes sequences of a plurality of embedding vectors and outputs a first vector expression for each sequence or a second vector expression for all sequences, and a neural network classifier that receives the first vector expression or the second vector expression to determine the class. However, the present disclosure is not limited thereto.

According to some exemplary embodiments of the present disclosure, the class may be related to the subject word of the document data. That is, the storage unit 120 may store a subject word corresponding to each of a plurality of class values. In addition, the processor 110 may infer to which subject word the document data corresponds based on the class output from the second network model.

According to software implementation, embodiments such as a procedure and a function described in the present disclosure may be implemented by separate software modules. Each of the software modules may perform one or more functions and operations described in the specification. A software code may be implemented by a software application written by an appropriate program language. The software code may be stored in the storage unit 120 of the computing device 100 and executed by the processor 110 of the computing device 100.

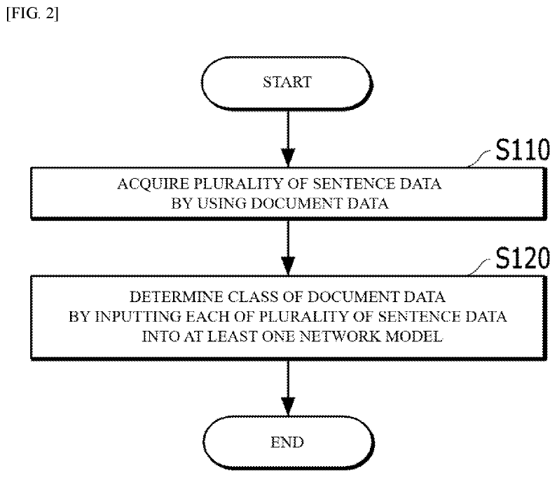

Hereinafter, the method for performing subject word classification of document data will be described in more detail with reference to FIGS. 2 to 4.

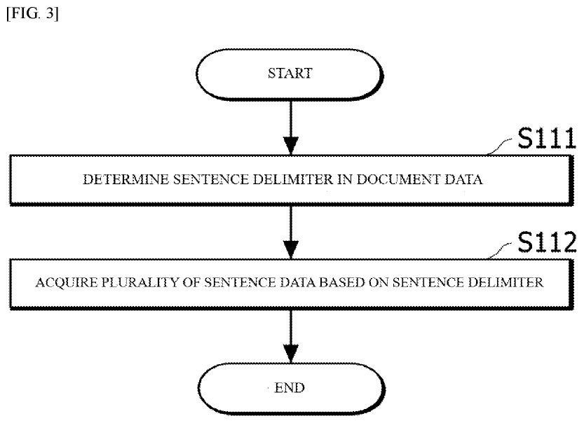

FIG. 2 is a diagram for describing an example of a method for performing subject word classification of document data according to some exemplary embodiments of the present disclosure. FIG. 3 is a diagram for describing an example of a method for acquiring a plurality of sentence data by using document data according to some exemplary embodiments of the present disclosure.

Referring to FIG. 2, the processor 110 may acquire a plurality of sentence data by using document data (S110). Here, the document data may include thesis document data, patent document data, and journal document data included in a public academic information system. However, the present disclosure is not limited thereto.

Meanwhile, the sentence data may include a plurality of texts or natural language character strings included in one sentence. However, the present disclosure is not limited thereto.

Step S110 will be described below in detail with reference to FIG. 3.

The processor 110 may determine a sentence delimiter in the document data when acquiring the plurality of sentence data by using the document data (S111). Here, the sentence delimiter may be a symbol (e.g., a period) or a specific text for distinguishing the end and the start of the sentence. However, the present disclosure is not limited thereto.

Meanwhile, since there are various types of document data, the sentence delimiters may also exist in various types, and the sentence delimiter may not exist at a location where the sentence delimiter should exist. In this case, since the sentence delimiter may not be determined, a problem in that the plurality of sentence data may not be acquired.

In order to solve the problem, in the present disclosure, when determining the sentence delimiter in the document data, the processor 110 may determine the sentence delimiter for a plurality of text data included in the document data based on a normal expression equation. Further, the processor 110 may determine the sentence delimiter through a model learned for delimitation of the sentence. For example, the model learning for the delimitation of the sentence may be a model that outputs the sentence delimiter for the text data by receiving the text data as an input. As another example, the model learned for the delimitation of the sentence may be a model that converts the input text data into text data including the sentence delimiter.

When the sentence delimiter is determined by using the normal expression equation and a learned sentence segment model, a document may be divided into more accurate sentence units. However, the present disclosure is not limited thereto.

Meanwhile, when the sentence delimiter is determined in step S111, the processor 110 may acquire the plurality of sentence data based on the sentence delimiter (S112).

Specifically, the processor 110 may acquire the plurality of sentence data by separating a sentence which exists before a location where the sentence delimiter exists and after a sentence which exists after the location. However, although not limited thereto, the processor 110 according to some exemplary embodiments of the present disclosure may acquire the plurality of sentence data through various methods.

Referring back to FIG. 2, when acquiring the plurality of sentence data by using the document data in step S110, the processor 110 may determine a class of the document data by inputting each of the plurality of sentence data into at least one network model (S120). Here, the class of the document data may be data indicating to which subject word the document data is related.

According to some exemplary embodiments of the present disclosure, at least one network model may include a first network model determining a plurality of embedding vector by being input with each of the plurality of sentence data and a second network model determining the class of the document data by being input with the plurality of embedding vectors. However, although not limited thereto, at least one network model may include network models more or less than the network models.

At least one network model of the present disclosure may be learned by using a learning data set in which the subject word is labeled to an abstract of each of a plurality of thesis data. Specifically, the processor 110 may input the learning data set into at least one network model, and calculate an output value. In addition, the processor 110 may calculate a difference between the output value and a value labeled to each learning data set, and update at least one parameter included in the at least one network model by backpropagation of the difference. In this case, at least one parameter may be updated by a scheme of updating all parameters included in at least one network model at one time, i.e., an end-to-end scheme. When learning is performed as described above, document classification performance may be enhanced.

Meanwhile, the plurality of embedding vectors output from the first network model may be mapped onto a vector space, and a similarity between the plurality of embedding vectors mapped onto the vector space may vary depending on a semantic similarity and relevancy of the sentence data.

As an example, when first sentence data and second sentence data are sentence data having a semantic similarity, a distance between a first embedding vector acquired by inputting the first sentence data into the first network model and a second embedding vector acquired by inputting the second sentence data into the first network model on the vector space may be short.

As another example, when first sentence data and second sentence data are sentence data having a semantic difference, a distance between a first embedding vector acquired by inputting the first sentence data into the first network model and a second embedding vector acquired by inputting the second sentence data into the first network model on the vector space may be long.

Meanwhile, the first network model may be a pretrained sentence embedding model. Here, in the case of the pretrained sentence embedding model, various types of natural language processing models such as a Bidirectional Encoder Representations form Transformers (BERT) model, a Generative Pre-trained Transformer (GPT) model, a Text-to-Text Transfer Transformer (T5) model, and a Sentence Bidirectional Encoder Representations form Transformers (SBERT) model may be used as the first network model. However, the present disclosure is not limited thereto.

In the present disclosure, it may be suitable that the SBERT model is used as the first network model. Here, the SBERT model may be a model learned to better perform sentence embedding by additionally learning the BERT model learned by using a large amount of corpus data by using the learning data set. However, the present disclosure is not limited thereto.

A method for learning the first network model may be performed through a next sentence prediction (NSP) learning method that guesses whether two random sentences are continuous sentences or discontinuous sentences, and a masked language model (MLM) learning method that masks a random word in the sentence and guesses the masked word. However, the present disclosure is not limited thereto.

Meanwhile, according to some exemplary embodiments of the present disclosure, the second network model may include an encoder that outputs a vector expression by gathering the plurality of embedding vectors as one and a neural network classifier that determines the class by being input with the vector expression output from the encoder. However, the present disclosure is not limited thereto.

Specifically, the encoder may encode sequences of the plurality of embedding vectors, and output a first vector expression for each of the sequences or a second vector expression for all sequences. Here, the encoder may have a structure corresponding to an encoding layer of a transformer model which is generally used for natural language processing in the related art. However, the present disclosure is not limited thereto.

In general, the encoding layer of the transformer model as a model used for encoding the sequence of the embedding vector may be used primarily for acquiring the vector expression for an element of each sequence or the vector expression for all sequences. Accordingly, in the present disclosure, in order to acquire the first vector expression for each sequence or the second vector expression for all sequences by encoding the sequences of the plurality of embedding vectors, the encoding layer of the transformer model may be used as the encoder. In this case, the second network model may be lower in complexity and higher in quality of encoding than a recurrent neural network (RNN) based sequence encoding model.

Meanwhile, the neural network classifier may determine the class by being input with the first vector expression or the second vector expression output from the encoder. Here, the class may be information related to the subject word of the document data.

Specifically, the neural network classifier may include a linear layer and a softmax layer. In this case, when the first vector expression or the second vector expression is input into the neural network classifier, the neural network classifier may output a probability value related to each of a plurality of classes. In this case, the processor 110 may determine a class related to the subject word of the document data as a class having a highest probability value. That is, when the vector expression is input, the neural network classifier may determine into which class among a plurality of classes which are pre-defined the corresponding vector expression is class. However, the present disclosure is not limited thereto.

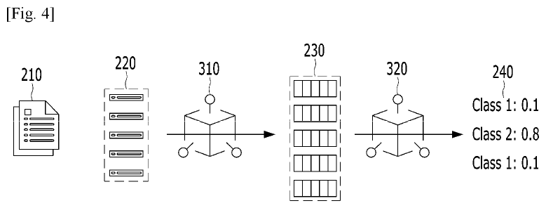

FIG. 4 is a flowchart for describing an example of a method for performing subject word classification of document data according to some exemplary embodiments of the present disclosure.

Referring to FIG. 4, document data 210 may include thesis document data, patent document data, and journal document data included in a public academic information system. However, the present disclosure is not limited thereto.

The processor 110 may acquire a plurality of sentence data 220 by using the document data 210.

Specifically, the processor 110 may determine a sentence delimiter in the document data when acquiring the plurality of sentence data by using the document data. Here, the sentence delimiter may be a symbol (e.g., a period) or a specific text for distinguishing the end and the start of the sentence. However, the present disclosure is not limited thereto.

According to some exemplary embodiments of the present disclosure, when determining the sentence delimiter in the document data, the processor 110 may determine the sentence delimiter for a plurality of text data included in the document data based on a normal expression equation. Further, the processor 110 may determine the sentence delimiter through a model learned for delimitation of the sentence. When the sentence delimiter is determined by using the normal expression equation and a learned sentence segment model, a document may be divided into more accurate sentence units. However, the present disclosure is not limited thereto.

Meanwhile, when the sentence delimiter is determined, the processor 110 may acquire the plurality of sentence data 220 based on the sentence delimiter.

Specifically, the processor 110 may acquire the plurality of sentence data 220 by separating a sentence which exists before a location where the sentence delimiter exists and after a sentence which exists after the location. However, although not limited thereto, the processor 110 according to some exemplary embodiments of the present disclosure may acquire the plurality of sentence data 220 through various methods.

When acquiring the plurality of sentence data by using the document data, the processor 110 may determine a plurality of embedding vectors 230 by inputting each of the plurality of sentence data into a first network model 310.

The first network model 310 may be a pretrained sentence embedding model. Here, in the case of the pretrained sentence embedding model, various types of natural language processing models such as a Bidirectional Encoder Representations form Transformers (BERT) model, a Generative Pre-trained Transformer (GPT) model, a Text-to-Text Transfer Transformer (T5) model, and a Sentence Bidirectional Encoder Representations form Transformers (SBERT) model may be used as the first network model. However, the present disclosure is not limited thereto. In the present disclosure, it may be suitable that the SBERT model is used as the first network model 310. Here, the SBERT model may be a model learned to better perform sentence embedding by additionally learning the BERT model learned by using a large amount of corpus data by using the learning data set. However, the present disclosure is not limited thereto.

Meanwhile, the plurality of embedding vectors 230 output from the first network model 310 may be mapped onto a vector space, and a similarity between the plurality of embedding vectors 230 mapped onto the vector space may vary depending on a semantic similarity and/or relevancy of the sentence data. In judging the similarity and/or the relevancy, for example, a distance between the embedding vectors 230 on the vector space may be considered. When the distance between the embedding vectors 230 on the vector space is short, it may be judged that the similarity and/or the relevancy is high.

As an example, when first sentence data and second sentence data are sentence data having a semantic similarity, a distance between a first embedding vector acquired by inputting the first sentence data into the first network model and a second embedding vector acquired by inputting the second sentence data into the first network model on the vector space may be short.

As another example, when first sentence data and second sentence data are sentence data having a semantic difference, a distance between a first embedding vector acquired by inputting the first sentence data into the first network model and a second embedding vector acquired by inputting the second sentence data into the first network model on the vector space may be long.

Meanwhile, when the processor 110 acquires the plurality of embedding vectors 230, the processor 110 may determine a class 240 by inputting the plurality of embedding vectors 230 into a second network model 320.

The second network model 320 may include an encoder that outputs a vector expression by gathering the plurality of embedding vectors 230 as one and a neural network classifier that determines the class by being input with the vector expression output from the encoder. However, the present disclosure is not limited thereto.

In general, the encoding layer of the transformer model as a model used for encoding the sequence of the embedding vector may be used primarily for acquiring the vector expression for an element of each sequence or the vector expression for all sequences. Accordingly, in the present disclosure, in order to acquire the first vector expression for each sequence or the second vector expression for all sequences by encoding the sequences of the plurality of embedding vectors, the encoding layer of the transformer model may be used as the encoder. In this case, the second network model may be lower in complexity and higher in quality of encoding than a recurrent neural network (RNN) based sequence encoding model.

Meanwhile, the neural network classifier may determine the class by being input with the first vector expression or the second vector expression output from the encoder. Here, the class may be information related to the subject word of the document data.

Specifically, the neural network classifier may include a linear layer and a softmax layer. In this case, when the first vector expression or the second vector expression is input into the neural network classifier, the neural network classifier may output a probability value related to each of a plurality of classes 240. In this case, the processor 110 may determine a class related to the subject word of the document data as a class having a highest probability value. That is, when the vector expression is input, the neural network classifier may determine into which class among a plurality of classes which are pre-defined the corresponding vector expression is class. However, the present disclosure is not limited thereto.

More specifically, when it is assumed that a pre-defined class includes class 1, class 2, and class 3, a value related to class 1, a value related to class 2, and a value related to class 3 may be output from the neural network classifier. In this case, the processor 110 may determine that the corresponding vector expression may be classified into a class (class 2 in FIG. 4) having a highest value. However, the present disclosure is not limited thereto.

Meanwhile, according to some exemplary embodiments of the present disclosure, the first network model 310 and the second network model 320 may be learned by using a learning data set in which the subject word is labeled to the abstract of each of the plurality of thesis data.

Specifically, the processor 110 may input the learning data set into the first network model 310 and the second network model 320, and then calculate an output value. In addition, the processor 110 may calculate a difference between the output value and a value labeled to each learning data set, and update at least one parameter included in the first network model 310 and the second network model 320 by backpropagation of the difference. In this case, at least one parameter may be updated by a scheme of updating all parameters included in the first network model 310 and the second network model 320 at one time, i.e., by an end-to-end scheme. When learning is performed as described above, document classification performance may be enhanced.

According to some exemplary embodiments of the present disclosure, a length limitation problem which occurs when embedding the document data can be solved, and when the subject word corresponding to the document data is classified, classification performance can be enhanced.

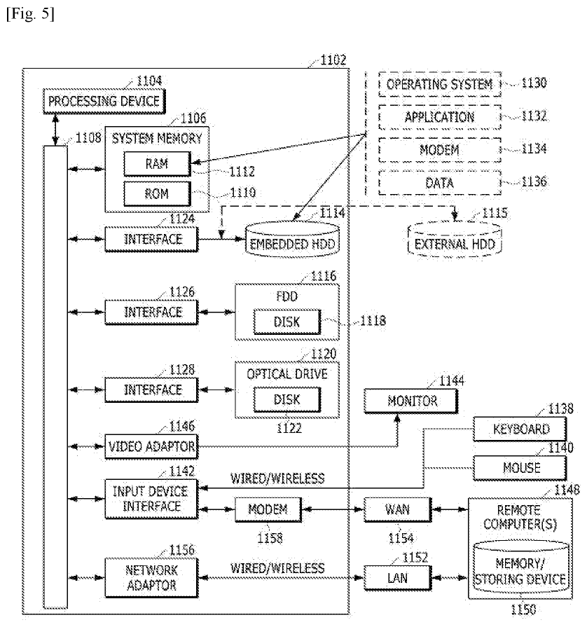

FIG. 5 is a normal and schematic view of an exemplary computing environment in which the exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment 1100 that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at one time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical disk drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a microprocessor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various exemplary embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for performing subject word classification of document data, which is performed by a computing device including at least one processor, the method comprising:
acquiring a plurality of sentence data by using document data; and
determining a class of the document data by inputting each of the plurality of sentence data into at least one network model.

2. The method of claim 1, wherein the acquiring of the plurality of sentence data by using document data includes
determining a sentence delimiter in the document data, and
acquiring the plurality of sentence data based on the sentence delimiter.

3. The method of claim 2, wherein the determining of the sentence delimiter in the document data includes
determining the sentence delimiter based on a normal expression equation and a pretrained sentence distinguishing model for a plurality of text data included in the document data.

4. The method of claim 3, wherein the pretrained sentence distinguishing model receives a sentence included in the document data and outputs a segment result for the input sentence.

5. The method of claim 1, wherein at least one network model includes
a first network model determining a plurality of embedding vectors by receiving each of the plurality of sentence data, and
a second network model determining the class by receiving the plurality of embedding vectors.

6. The method of claim 5, wherein the second network model includes
an encoder encoding sequences of the plurality of embedding vectors, and outputting a first vector expression for each of the sequences or a second vector expression for all sequences, and
a neural network classifier determining the class by receiving the first vector expression or the second vector expression.

7. The method of claim 6, wherein the class is related to the subject word of the document data.

8. The method of claim 1, wherein the at least one network model is learned by using a learning data set in which the subject word is labeled to an abstract of each of a plurality of thesis data.

9. A computing device for performing subject word classification of document data, comprising:
a storage unit storing at least one network model; and
a processor acquiring a plurality of sentence data by using document data, and determining a subject word of the document data by inputting each of the plurality of sentence data into the at least one network model.

10. The computing device of claim 9, wherein the processor
determines a sentence delimiter in the document data, and
acquires the plurality of sentence data based on the sentence delimiter.

11. The computing device of claim 10, wherein the processor determines the sentence delimiter based on a normal expression equation and a pretrained sentence distinguishing model for a plurality of text data included in the document data.

12. The computing device of claim 9, wherein at least one network model includes
a first network model determining a plurality of embedding vectors by receiving each of the plurality of sentence data, and
a second network model determining the subject word by receiving the plurality of embedding vectors.

13. The computing device of claim 12, wherein the second network model includes
an encoder encoding sequences of the plurality of embedding vectors, and outputting a first vector expression for each of the sequences or a second vector expression for all sequences, and
a neural network classifier outputting a class value by receiving the first vector expression or the second vector expression.

14. The computing device of claim 9, wherein the at least one network model is learned by using a learning data set in which the subject word is labeled to an abstract of each of a plurality of thesis data.

15. A non-transitory computer readable medium storing a computer program, wherein the computer program comprises instructions for causing one or more processors of a computing device to perform the following steps for subject word classification of document data, the steps comprising:
acquiring a plurality of sentence data by using document data; and
determining a subject word of the document data by inputting each of the plurality of sentence data into at least one network model.
